(19) United States
(12) Patent Application Publication
(10) Pub. No.: US 2026/0336214 A1
(43) Pub. Date: Oct. 29, 2026

(54) ARC-LASER HYBRID SYNCHRONOUS IN-SITU MICRO-ROLLING ADDITIVE MANUFACTURING DEVICE AND METHOD

(71) Applicant: Huazhong University of Science and Technology, Wuhan City (CN)

(72) Inventors: Haiou ZHANG, Wuhan City (CN); Mingxin LIU, Wuhan City (CN); Hang LIN, Wuhan City (CN); Mingtian WANG, Wuhan City (CN); Guilan WANG, Wuhan City (CN)

(21) Appl. No.: 19/346,102

(22) Filed: Sep. 30, 2025

(30) Foreign Application Priority Data
Apr. 28, 2025 (CN) 202510549635.5

(51) Int. Cl. B29C 64/277; B23K 9/04; B23K 26/342; B29C 64/268; B33Y 10/00; B33Y 30/00

(52) U.S. Cl. CPC B29C 64/277; B23K 9/04; B23K 26/342; B29C 64/268; B33Y 10/00; B33Y 30/00

(57) ABSTRACT

An arc-laser hybrid synchronous in-situ micro-rolling additive manufacturing device and method are provided, relating to the technical field of additive manufacturing. The device includes a main heat source, a laser heat source, a welding wire and a rolling equipment that are arranged on a same structure and can be moved synchronously, where the laser heat source includes a galvanometer scanner assembly, the galvanometer scanner assembly is configured to oscillate a laser beam emitted by the laser heat source, and the laser heat source is configured to regulate a molten pool formed by the main heat source.

### CROSS-REFERENCE TO RELATED APPLICATION

This patent application claims the benefit and priority of Chinese Patent Application No. 202510286518.4 filed with the China National Intellectual Property Administration on Mar. 12, 2025, the disclosure of which is incorporated by reference herein in its entirety as part of the present application.

### TECHNICAL FIELD

The present disclosure relates to the technical field of additive manufacturing, and in particular to an arc-laser hybrid synchronous in-situ micro-rolling additive manufacturing device and method.

### BACKGROUND

Compared with the conventional manufacturing technology, additive manufacturing, as a technology to directly manufacture digital models into three-dimensional solid parts in a layered way, has the advantages of high speed and low cost. The application of additive manufacturing technology can achieve integrated additive manufacturing of complex parts. For difficult-to-process materials, additive manufacturing shortens the manufacturing cycle of a workpiece due to its small manufacturing margin. Therefore, the additive manufacturing technology is of a great significance in the aerospace field and other occasions where difficult-to-machine materials are widely used. Arc additive manufacturing, as an important branch technology of metal additive manufacturing, is widely used in additive manufacturing industry due to its advantages of low cost and high efficiency. However, low energy density and large heat affected zone of the arc additive manufacturing may lead to low manufacturing accuracy, coarse grains of finished products and inferior mechanical properties to forgings, and it is difficult to meet the manufacturing requirements of high quality, high efficiency and low cost in the actual production process.

### SUMMARY

An objective of the present disclosure is to provide arc-laser hybrid synchronous in-situ micro-rolling additive manufacturing device and method. By utilizing a laser hybrid heat source to simultaneously increase energy density and achieve laser regulation, thereby achieving additive manufacturing with high efficiency, high quality and short process.

To achieve the objective described above, the present disclosure provides the following solutions.

In a first aspect, the present disclosure provides an arc-laser hybrid synchronous in-situ micro-rolling additive manufacturing device, including a main heat source, a laser heat source, a welding wire, and a rolling equipment.

The main heat source, the laser heat source, the welding wire and the rolling equipment are arranged on a same structure, and are configured to move synchronously.

The laser heat source includes a galvanometer scanner assembly.

The galvanometer scanner assembly is configured to oscillate a laser beam emitted by the laser heat source.

The laser heat source is configured to regulate a molten pool formed by the main heat source.

Alternatively, the galvanometer scanner assembly includes an X-axis galvanometer scanner and a Y-axis galvanometer scanner, and an amplitude of the galvanometer scanner is 0-5 mm.

Relative positions of the laser heat source and the welding wire can be adjusted.

The laser heat source has a laser power of 0 -3000 W, and an included angle between an incident laser beam and the main heat source is 30-60°.

Alternatively, the main heat source, the laser heat source, the welding wire and the rolling equipment are mounted on a machine tool spindle, and are configured to move synchronously with the machine tool spindle.

Alternatively, the welding wire is located directly below the main heat source and is fixed to a same motion unit as the main heat source.

The rolling equipment is located behind the main heat source and is fixed to a same motion unit as the main heat source, and the rolling equipment is configured to perform in-situ synchronous rolling on a formed weld bead.

Alternatively, the main heat source is a welding torch, the welding torch has a welding current of 0 -300 A; and
the rolling equipment is a roller.

Alternatively, the device further includes an infrared thermal imager, a line laser detector, and a CCD (Charge Coupled Device) camera.

The infrared thermal imager is configured to monitor a temperature of an additive workpiece in a forming process in real time; and
the line laser detector and the CCD camera are configured to monitor surface flatness and surface defects of the additive workpiece in the forming process in real time.

In a second aspect, the present disclosure provides an arc-laser hybrid synchronous in-situ micro-rolling additive manufacturing method, including the following steps:
acquiring a forming path;
generating a synchronous control instruction based on the forming path, wherein the synchronous control instruction is configured to control synchronized movement of a main heat source, a laser heat source, a welding wire and a rolling equipment; controlling the laser heat source to emit a laser beam to a molten pool after the molten pool is formed below the main heat source, and controlling a galvanometer scanner assembly on the laser heat source to oscillate the laser; and
controlling the main heat source, the laser heat source, the welding wire and the rolling equipment to carry out in-situ synchronous hot-rolling after the molten pool is solidified.

Alternatively, after controlling the main heat source, the laser heat source, the welding wire and the rolling equipment to carry out in-situ synchronous hot-rolling after the molten pool is solidified, the method further includes:
detecting, by a line laser measurement instrument or a CCD camera, an additive workpiece obtained after in-situ synchronous hot-rolling; and
controlling the laser heat source to remelt the additive workpiece when defects are detected in the additive workpiece.

Alternatively, when a temperature of the additive workpiece is lower than a preset threshold, the method further includes controlling the laser heat source to heat the additive workpiece.

Alternatively, in a process of in-situ synchronous hot-rolling, the method further includes: controlling a current of the main heat source to be 160-260 A, a laser power of the laser heat source to be 500 -1500 W, a wire feeding speed of the welding wire to be 2-4 m/min, and a rolling force of hot-rolling to be 15-30 kN.

According to specific embodiments of the present disclosure, the present disclosure has the following technical effects.

The present disclosure provides an arc-laser hybrid synchronous in-situ micro-rolling additive manufacturing device and method. The device includes a main heat source, a laser heat source, a welding wire, and a rolling equipment. The main heat source, the laser heat source, the welding wire and the rolling equipment are arranged on a same structure and can be moved synchronously, where the laser heat source includes a galvanometer scanner assembly, the galvanometer scanner assembly is configured to oscillate a laser beam emitted by the laser heat source; and the laser heat source is configured to control a molten pool formed by the main heat source. According to the present disclosure, the laser heat source is used as an auxiliary heat source, thereby increasing a heat input in an additive manufacturing process and significantly increasing deposition efficiency in the additive manufacturing process. Meanwhile, the galvanometer scanner assembly is arranged in the laser heat source to make the laser beam emitted by the laser heat source oscillate, thereby regulating the molten pool formed by the main heat source and making the molten pool more uniformly. In addition, oscillating laser can accelerate the flow of the molten pool, make micro bubbles generated by the molten pool in the additive manufacturing process escape from the molten pool more rapidly and reduce the size and quantity of pores in the additive forming process, thereby effectively improving the forming quality of an additive workpiece. Therefore, The present disclosure utilizes the laser hybrid heat source combined with synchronous micro-rolling to simultaneously increase energy density and achieve laser regulation, thereby achieving additive manufacturing with high efficiency, high quality and short process.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a structural diagram of a laser source with X-axis and Y-axis galvanometer scanners according to an embodiment of the present disclosure;

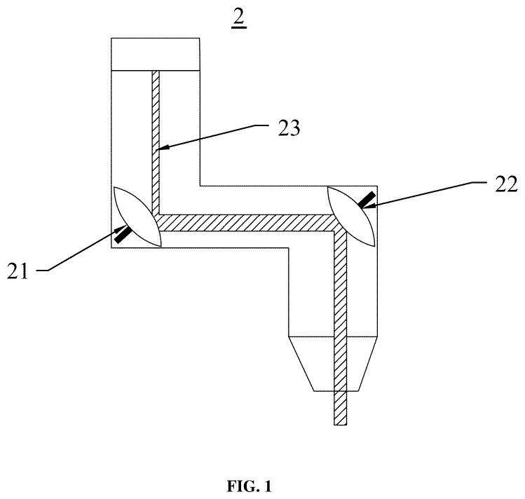

FIG. 2 is a diagram of a working principle of an arc-laser hybrid synchronous in-situ micro-rolling additive manufacturing device according to an embodiment of the present disclosure;

FIG. 3 is a diagram of a printing path forming process according to an embodiment of the present disclosure;

FIG. 4 is a diagram of a defect detection process according to an embodiment of the present disclosure.

In the figures: 1—Main heat source; 2—Laser heat source; 3—Welding wire; 4—Rolling equipment; 21—X-axis galvanometer scanner; 22—Y-axis galvanometer scanner; 23—Laser beam; P—motion direction.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

In the present disclosure, the additive manufacturing with high efficiency, high quality and short process is achieved by using laser hybridization and synchronous micro-rolling. The use of laser as an auxiliary heat source increases thermal input, thereby improving the forming efficiency in the additive manufacturing process. Meanwhile, the oscillating laser is used to regulate a molten pool, resulting in a more uniform molten pool. Additionally, The oscillating laser can accelerate the flow of the molten pool, enabling micro bubbles generated by the molten pool in the additive manufacturing process to escape the molten pool more rapidly.

In an example embodiment, the present disclosure provides an arc-laser hybrid synchronous in-situ micro-rolling additive manufacturing device, including a main heat source 1, a laser heat source 2, a welding wire 3 and a rolling equipment 4.

The main heat source 1, the laser heat source 2, the welding wire 3 and the rolling equipment 4 are arranged on a same structure and can be moved synchronously.

The laser heat source 2 includes a galvanometer scanner assembly, the galvanometer scanner assembly is configured to oscillate a laser beam 23 emitted by the laser heat source 2, and the laser heat source 2 is configured to control a molten pool formed by the main heat source 1.

In this embodiment, the galvanometer scanner assembly includes an X-axis galvanometer scanner 21 and a Y-axis galvanometer scanner 22, and an amplitude of the galvanometer scanner is 0-5 mm.

In this embodiment, relative positions of the laser heat source 2 and the welding wire 3 can be adjusted. The laser heat source 2 has a laser power of 0 -3000 W, and an included angle between an incident laser beam and the main heat source 1 is 30-60°.

The main heat source 1, the laser heat source 2, the welding wire 3 and the rolling equipment 4 are mounted on a machine tool spindle and are configured to move synchronously with the machine tool spindle. In this embodiment, specifically, a welding torch, a wire feeder, a laser head and a roller are arranged on the machine tool spindle, while other larger structures such as a laser emitter and an arc emitter are adaptively arranged.

The welding wire 3 is located directly below the main heat source 1 and is fixed to a same motion unit as the main heat source 1. The rolling equipment 4 is located behind the main heat source 1 and is fixed to the same motion unit as the main heat source 1. The rolling equipment 4 is configured to carry out in-situ synchronous rolling on a formed weld bead.

In this embodiment, the main heat source 1 is a welding torch, the welding torch has a welding current of 0 -300 A. The rolling equipment 4 is a roller.

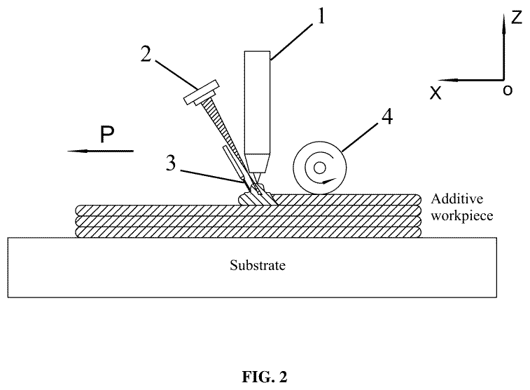

When the foregoing device is used for additive manufacturing, the working principle thereof is as shown in FIG. 2, which specifically may employ the following ways.

In the manufacturing process, a hybrid heat source (main heat source+laser heat source), the welding wire 3 and the roller are driven by the motion unit to move along a preset path, the laser head of the laser heat source 2 and the welding torch are used as heat sources for melting the welding wire 3, thereby depositing the molten welding wire 3 on a substrate to form an additive workpiece. The roller is configured to roll the formed weld bead, thereby improving its forming quality. The welding torch, as the main heat source 1 in the manufacturing process, may employ an arc welding torch/plasma arc welding torch. The welding wire 3 should be fed to a position directly below the welding torch with a wire feeding rate of 0-6 m/min, and is fixed to the same motion unit as the welding torch. The roller is located behind the welding torch and is fixed to the same motion unit as the welding torch, thereby carrying out in-situ synchronous rolling on the formed weld bead with a rolling force ranging from 0 to 30000 N. In the forming method, an infrared thermal imager, a line laser detector and a CCD camera should be provided as detection equipments, which are configured to monitor a temperature, surface flatness and surface defects in the forming process in real time.

In the present disclosure, by using synchronous micro-rolling, both synchronous grain refinement in the additive manufacturing process and additive manufacturing of equiaxed fine-grained parts are achieved, which comprehensively improve the strength and toughness of materials. Moreover, the performance of a formed product is improved by synchronous in-situ micro-rolling, and no post-treatment such as subsequent die forging or hot isostatic pressing is needed. In addition, after rolling, the surface is smoother, and continuous forming can be carried out as there is no need to introduce interlayer milling. By carrying out in-situ synchronous micro-rolling on the weld bead after additive forming, the material after forming is hot-rolled to undergo dynamic recrystallization, which can transform initial coarse grains into fine equiaxed grains, thereby achieving grain refinement. Prior art has employed synchronous micro-rolling for grain refinement, whereas ultrasonic impact is dominant.

Compared with the prior art, this embodiment has the following distinctive features and advantages.

In this embodiment, the heat input in the additive manufacturing process can be increased through an arc-laser hybrid heat source, thereby significantly improving deposition efficiency in the additive manufacturing process.

In this embodiment, oscillating laser is introduced to regulate the molten pool, which can accelerate bubbles escape in the forming process and reduce the size and quantity of pores in the additive forming process.

In this embodiment, synchronous micro-rolling is introduced to achieve grain refinement in the additive manufacturing process, and ultra-fine equiaxed fine grains are obtained to achieve a comprehensive improvement in the strength and toughness of the material.

Based on the same inventive concept, an embodiment of the present disclosure further provides an arc-laser hybrid synchronous in-situ micro-rolling additive manufacturing method. A hybrid heat source, a welding wire 3 and a roller are driven by a motion unit to move along a preset path, a laser head and a welding torch are used as heat sources for melting the welding wire 3, thereby depositing the molten welding wire 3 on a substrate to form an additive workpiece. The roller is configured to roll a formed weld bead, thereby improving its forming quality. The method mainly includes the following steps.

S1. A forming path is acquired.

S2. A synchronous control instruction is generated based on the forming path, where the synchronous control instruction is configured to control synchronized movement of a main heat source 1, a laser heat source 2, a welding wire 3 and a rolling equipment 4.

S3. The laser heat source 2 is controlled to emit a laser beam 23 to a molten pool after the molten pool is formed below the main heat source 1, and a galvanometer scanner assembly on t he laser heat source 2 is control to oscillate the laser beam.

S4. After the molten pool is solidified, the main heat source 1, the laser heat source 2, the welding wire 3 and the rolling equipment 4 are controlled to carry out in-situ synchronous hot-rolling.

As a specific implementation, the following methods can be selected in this embodiment to specifically complete the additive manufacturing process.

In the additive forming process, the device is configured to read the forming path to determine a motion path of the device, then an arc is formed between the welding torch and a substrate or an additive workpiece, and the welding wire 3 is fed into the arc to melt to form a molten pool directly below the welding torch. After the molten pool is formed, the laser beam is injected into the molten pool, and the laser beam is oscillated to regulate the molten pool through the galvanometer scanner assembly inside the laser head (where the galvanometer scanner assembly is mounted inside the laser head, and the laser beam oscillates along a motion direction P or perpendicular to the motion direction P through an X-axis galvanometer scanner 21 and a Y-axis galvanometer scanner 22, and is injected into the molten pool to accelerate the flowing of the molten pool and serve the purpose of stirring the molten pool), which can accelerate bubbles escape from the molten pool. The galvanometer scanner assembly has an amplitude of 0-5 mm and an oscillating frequency of 0 -500 Hz. An included angle between an incident laser beam and the welding torch is 30-60°. After the molten pool solidifies to form the weld bead, the roller synchronously carries out in-situ synchronous hot rolling on the weld bead (the roller descends and rolls a newly formed weld bead according to a preset rolling force to achieve grain refinement of the weld bead and make a formed surface smoother). In the in-situ synchronous hot rolling process, a forming current is 160-260 A, a laser power is 500 -1500 W, a wire feeding rate of the welding wire 3 is 2-4 m/min, a forming walking rate is 200-400 mm/min, and a rolling force of hot-rolling is 15-30 kN.

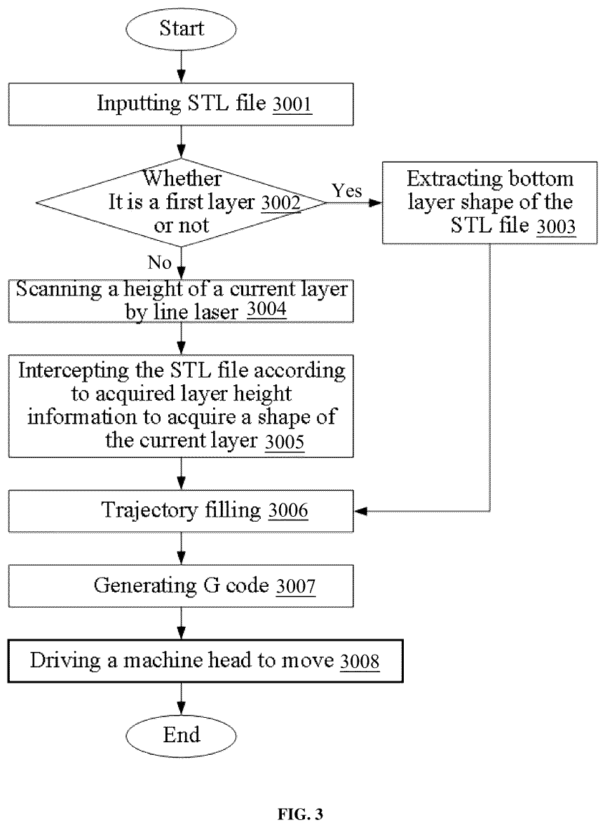

The welding torch, the laser head, the welding wire 3 and the roller move synchronously according to a preset motion program, and required additive parts are formed by layered deposition. An arc generated by the welding torch is used as the main heat source 1, which is used to melt the welding wire 3 and form the molten pool, and the laser head generates the laser beam, the laser beam enters the molten pool formed by the arc to regulate the molten pool. The roller is configured to roll the weld bead that has been formed. A forming process of a printing path is as shown in FIG. 3.

At the beginning of the printing, a bottom layer of an input printing model is sliced through slice software (the slice software extracts an STL (stereo lithography) file of an input model and identifies a printing direction thereof 3001, A determination is made as to whether a current slice is a first layer of slice 3002, If it is determined to be the first layer of slice a bottom surface of the model with a plane perpendicular to the printing direction is used to intercept a bottom surface of the model 3003, and an outline thereof is extracted as the first layer of slice), and a path is filled after a printing shape is acquired 3006, G codes are then generated 3007, and the welding torch, the laser head, the welding wire 3 and the roller are driven to operate in synchronized motion 3008. After completing the printing of one layer, the printed layer is scanned by line laser to read a currently printed layer height 3004. Based on the layer height information, the STL file is sliced again to generate a new printing path 3005. Parts formed using the foregoing process parameters can achieve high strength, high toughness, and high fatigue performance.

At the start of additive forming or in the additive forming process, if an initial temperature of the workpiece or substrate is low after an extended unplanned stoppage, the laser head can be firstly used to preheat the substrate or the additive workpiece with low-power laser (no more than 600 w) as an auxiliary heat source. After preheating, an infrared thermal camera is configured to identify a matrix temperature and determine whether the temperature meets a preset requirement. An infrared thermal imager is mounted on a forming equipment and does not have a motion module, and is configured to monitor a temperature of the substrate and additive workpiece after forming in real time. After the temperature meets the preset requirement, the additive forming process can be carried out. If the temperature does not meet the preset requirement, preheating is required again. This method can reduce a temperature gradient in the additive forming process to ensure uniform temperature in the forming process and improve the forming quality.

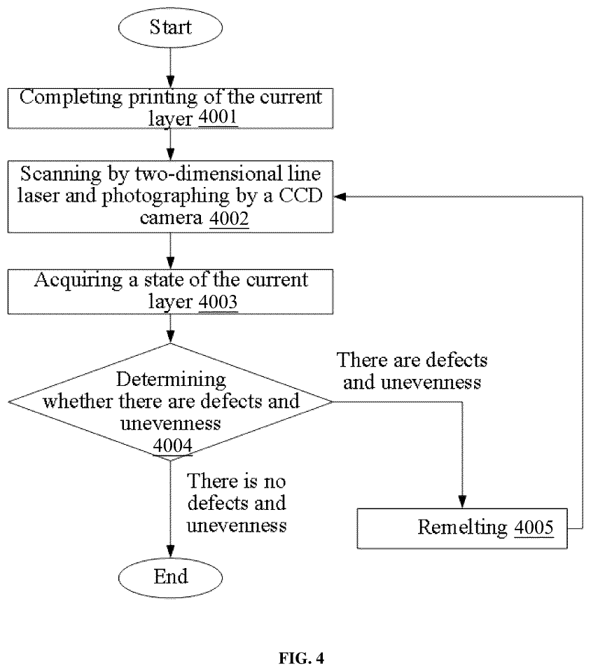

With reference to FIG. 4, After the additive workpiece is formed 4001, the additive workpiece is detected by a line laser measurement instrument or a CCD camera 4002, and status of the additive workpiece is acquired 4003, A determination is made as to whether unevenness or defects exists in the additive workpiece 4004, If the unevenness or the defects are present, the unevenness or defects can be solved by depositing the welding wire 3, or the feeding of the welding wire 3 can be stopped, and an arc formed by the welding torch and the additive workpiece is used as the main heat source 1 to remelt the weld bead along the forming path 4005, or the arc is not used in the remelting process, a surface of the weld bead is melted by a low-power laser of 300-500 w at a remelting rate of 200-400 mm/min. In the remelting process, only the Y-axis galvanometer scanner 22 with an amplitude of 5 mm and a frequency of 100 Hz is used, thereby achieving the purpose of remelting the uneven or surface defective areas to to make the surface smoother. In addition, the roller is configured to carry out in-situ hot rolling on the weld bead again to further eliminate the surface defects and improve the flatness of the weld bead. The line laser measurement instrument or the CCD camera is mounted on a machine head of an additive forming equipment and can move synchronously with the machine head. After each layer is printed, The line laser measurement instrument or the CCD camera is driven by the machine head to scan the formed surface morphology.

In conclusion, this embodiment includes the welding torch, the laser head, the welding wire 3 and the roller. The above four components are mounted on the machine head of the additive manufacturing device and can move synchronously in the forming process. The welding torch, as the main heat source 1 in the manufacturing process, may employ the arc welding torch/plasma arc welding torch. The laser head, as an auxiliary heat source, is provided with the X-axis galvanometer scanner 21 and the Y-axis galvanometer scanner 22, and the relative positions of the laser head and the welding wire 3 can be adjusted. The welding wire 3 should be fed to a position directly below the welding torch and is fixed to a same motion unit as the welding torch, and the roller is located behind the welding torch and is fixed to the same motion unit as the welding torch, thereby carrying out in-situ synchronous rolling on the formed weld bead.

In this embodiment, in the arc additive forming process, the laser is introduced to regulate the molten pool, which can increase the heat input in the forming process and eliminate the surface defects generated in the process of additive manufacturing in the form of laser remelting. In addition, the in-situ synchronous rolling is introduced into the arc additive process.

Through this embodiment, the strength, toughness and fatigue performance of the arc additive parts can be improved comprehensively.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

Several examples are used for illustration of the principles and implementations of the present disclosure. The description of the embodiments is merely used to help illustrate the method and its core principles of the present disclosure. In addition, a person of ordinary skill in the art can make various modifications in terms of specific implementations and scope of application in accordance with the teachings of the present disclosure. In conclusion, the content of this specification shall not be construed as a limitation to the present disclosure.

What is claimed is:

1. An arc-laser hybrid synchronous in-situ micro-rolling additive manufacturing device, comprising a main heat source, a laser heat source, a welding wire and a rolling equipment, wherein
the main heat source, the laser heat source, the welding wire and the rolling equipment are arranged on a same structure, and are configured to move synchronously;
the laser heat source comprises a galvanometer scanner assembly,
the galvanometer scanner assembly is configured to oscillate a laser beam emitted by the laser heat source; and
the laser heat source is configured to regulate a molten pool formed by the main heat source.

2. The arc-laser hybrid synchronous in-situ micro-rolling additive manufacturing device according to claim 1, wherein the galvanometer scanner assembly comprises an X-axis galvanometer scanner and a Y-axis galvanometer scanner, and an amplitude of the galvanometer scanner is 0-5 mm;
relative positions of the laser heat source and the welding wire are able to be adjusted;
the laser heat source has a laser power of 0 -3000 W, and an included angle between an incident laser beam and the main heat source is 30-60°.

3. The arc-laser hybrid synchronous in-situ micro-rolling additive manufacturing device according to claim 1, wherein the main heat source, the laser heat source, the welding wire and the rolling equipment are mounted on a machine tool spindle, and are configured to move synchronously with the machine tool spindle.

4. The arc-laser hybrid synchronous in-situ micro-rolling additive manufacturing device according to claim 1, wherein the welding wire is located directly below the main heat source and is fixed to a same motion unit as the main heat source;
the rolling equipment is located behind the main heat source and is fixed to the same motion unit as the main heat source, and the rolling equipment is configured to carry out in-situ synchronous rolling on a formed weld bead.

5. The arc-laser hybrid synchronous in-situ micro-rolling additive manufacturing device according to claim 1, wherein the main heat source is a welding torch, the welding torch has a welding current of 0 -300 A; and
the rolling equipment is a roller.

6. The arc-laser hybrid synchronous in-situ micro-rolling additive manufacturing device according to claim 1, further comprising an infrared thermal imager, a line laser detector, and a CCD (Charge Coupled Device) camera, wherein
the infrared thermal imager is configured to monitor a temperature of an additive workpiece in a forming process in real time; and
the line laser detector and the CCD camera are configured to monitor surface flatness and surface defects of the additive workpiece in the forming process in real time.

7. An arc-laser hybrid synchronous in-situ micro-rolling additive manufacturing method, comprising the following steps:
acquiring a forming path;
generating a synchronous control instruction based on the forming path, wherein the synchronous control instruction is configured to control synchronized movement of a main heat source, a laser heat source, a welding wire and a rolling equipment;
controlling the laser heat source to emit a laser beam to a molten pool after the molten pool is formed below the main heat source, and controlling a galvanometer scanner assembly on the laser heat source to oscillate the laser beam; and
controlling the main heat source, the laser heat source, the welding wire and the rolling equipment to carry out in-situ synchronous hot-rolling after the molten pool is solidified.

8. The arc-laser hybrid synchronous in-situ micro-rolling additive manufacturing method according to claim 7, wherein after controlling the main heat source, the laser heat source, the welding wire and the rolling equipment to carry out in-situ synchronous hot-rolling after the molten pool is solidified, the method further comprises:
detecting, by a line laser measurement instrument or a CCD camera, an additive workpiece obtained after in-situ synchronous hot-rolling; and
controlling the laser heat source to remelt the additive workpiece when defects are detected in the additive workpiece.

9. The arc-laser hybrid synchronous in-situ micro-rolling additive manufacturing method according to claim 7, wherein when a temperature of the additive workpiece is lower than a preset threshold, the method further comprises:
controlling the laser heat source to heat the additive workpiece.

10. The arc-laser hybrid synchronous in-situ micro-rolling additive manufacturing method according to claim 7, wherein in a process of in-situ synchronous hot-rolling, the method further comprises:
controlling a current of the main heat source to be 160-260 A, a laser power of the laser heat source to be 500 -1500 W, a wire feeding speed of the welding wire to be 2-4 m/min, and a rolling force of hot-rolling to be 15-30 kN.
